(19) United States
(12) Patent Application Publication
(10) Pub. No.: US 2012/0297060 A1
(43) Pub. Date: Nov. 22, 2012

(54) INFORMATION PROCESSING DEVICE, INFORMATION PROCESSING METHOD, AND COMPUTER PROGRAM

(75) Inventor: Hiroshi Takagi, Saitama (JP)

(73) Assignee: SONY CORPORATION, Tokyo (JP)

(21) Appl. No.: 13/459,439

(22) Filed: Apr. 30, 2012

(30) Foreign Application Priority Data
May 19, 2011 (JP) 2011-112419

(51) Int. Cl. G06F 15/16

(52) U.S. Cl. 709/224

(57) ABSTRACT

There is provided an information processing device including a device information acquisition unit configured to acquire information on other devices connected via a network, and a setting file creation unit configured to, on the basis of the information on the other devices acquired by the device information acquisition unit, create a setting file by causing the information processing device to describe in the setting file information on content that is managed by the information processing device, the setting file being adapted to be forwarded to the other devices. The setting file creation unit describes in the setting file an order in which the setting file is to be forwarded.

### CROSS-REFERENCE TO RELATED APPLICATION

The present application claims priority from Japanese Patent Application No. JP 2011-112419 filed in the Japanese Patent Office on May 19, 2011, the entire content of which is incorporated herein by reference.

### BACKGROUND

The present disclosure relates to an information processing device, an information processing method, and a computer program.

As networks have come into widespread use, electronic devices that can connect to the networks have also become more common. Nowadays, not only personal computers, but also electronic devices such as televisions, hard disk recorders, cameras, or portable phones commonly have a function to connect to a network, and such electronic devices have come to be able to interoperate with each other via a network (for example, see JP 2006-139432A).

A system has come into widespread use in which, by connecting the aforementioned electronic devices to a network in a home, content such as video or audio can be viewed through communication between the devices or between rooms in the home. Such a system is adapted to be able to cause video content, which is recorded on a hard disk recorder set in a living room, to be played back on a personal computer set in a study room that is away from the living room, for example.

### SUMMARY

When the number of devices that can connect to a network increases, the individual devices store content independently. Thus, when seen from the entire network, the amount of content stored increases with an increase in the number of devices that can connect to the network. However, so far, even if a plurality of devices having similar functions (e.g., a program recording function) reside within a network, the individual devices operate independently without interoperating with each other. Thus, there has been a wasteful process such that the plurality of devices perform totally the same operation (e.g., record the same program).

In the existing DLNA (Digital Living Network Alliance), a client/server model is used in which the server is responsible for providing a list of content and the client acquires a list of devices. However, in the DLNA, as the servers have no function of interoperating with each other, the client should acquire lists from all servers. Thus, a problem of overlaps should be solved.

In addition, in the DLNA, there is provided no means of sharing lists collected by a server. Thus, all the clients should perform the same process. Therefore, the amount of communication or the amount of computation across the entire network become huge.

In light of the foregoing, it is desirable to provide an information processing device, an information processing method, and a program that are novel and improved and that allow sharing of information without increasing the amount of communication or the amount of computation while avoiding the plurality of devices from executing the same operation by causing them to interoperate with each other.

According to an embodiment of the present disclosure, there is provided an information processing device including a device information acquisition unit configured to acquire information on other devices connected via a network, and a setting file creation unit configured to, on the basis of the information on the other devices acquired by the device information acquisition unit, create a setting file by causing the information processing device to describe in the setting file information on content that is managed by the information processing device, the setting file being adapted to be forwarded to the other devices. The setting file creation unit describes in the setting file an order in which the setting file is to be forwarded.

According to an embodiment of the present disclosure, a device information acquisition unit acquires information on other devices connected via a network, and the setting file creation unit, on the basis of the information on the other devices acquired by the device information acquisition unit, creates a setting file by causing the information processing device to describe in the setting file information on content that is managed by the information processing device, the setting file being adapted to be forwarded to the other devices. At this time, the setting file creation unit describes in the setting file an order in which the setting file is to be forwarded.

According to another embodiment of the present disclosure, there is provided an information processing method, including a device information acquisition step of acquiring information on other devices connected via a network, and a setting file creation step of, on the basis of the information on the other devices acquired by the device information acquisition step, creating a setting file by causing a device to describe in the setting file information on content that is managed by the device, the setting file being adapted to be forwarded to the other devices. The setting file creation step describes in the setting file an order in which the setting file is to be forwarded.

According to still another embodiment of the present disclosure, there is provided a computer program for causing a computer to execute a device information acquisition step of acquiring information on other devices connected via a network, and a setting file creation step of, on the basis of the information on the other devices acquired by the device information acquisition step, creating a setting file by causing a device to describe in the setting file information on content that is managed by the device, the setting file being adapted to be forwarded to the other devices. The setting file creation step describes in the setting file an order in which the setting file is to be forwarded.

According to the embodiments of the present disclosure described above, it is possible to provide an information processing device, an information processing method, and a computer program that are novel and improved and that allow sharing of information without increasing the amount of communication or the amount of computation across the entire network while avoiding a plurality of devices from executing the same operation by causing them to interoperate with each other.

### BRIEF DESCRIPTION OF THE DRAWINGS

FIG. 1 is an explanatory diagram showing the configuration of a content sharing system 1 in accordance with an embodiment of the present disclosure;

FIG. 2 is an explanatory diagram showing the functional configuration of a hard disk recorder 100;

FIG. 3 is an explanatory diagram showing the functional configuration of a control unit 140 included in the hard disk recorder 100;

FIG. 4 is a flowchart showing the operation of a device connected to a home network 10;

FIG. 5 is an explanatory diagram showing a summary of the operation of a device connected to the home network 10;

FIG. 6 is an explanatory diagram showing a summary of the operation of a device connected to the home network 10;

FIG. 7 is an explanatory diagram showing a summary of the operation of a device connected to the home network 10; and

FIG. 8 is an explanatory diagram showing an exemplary format of a token.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that the description will be given in the following order.

<1. Embodiment of the Present Disclosure>
[1-1. Exemplary Configuration of Content Sharing System]
[1-2. Functional Configuration of Device Connected to Home Network]
[1-3. Operation of Device Connected to Home Network]

<2. Conclusion>

### 1. Embodiment of the Present Disclosure

### [1-1. Exemplary Configuration of Content Sharing System]

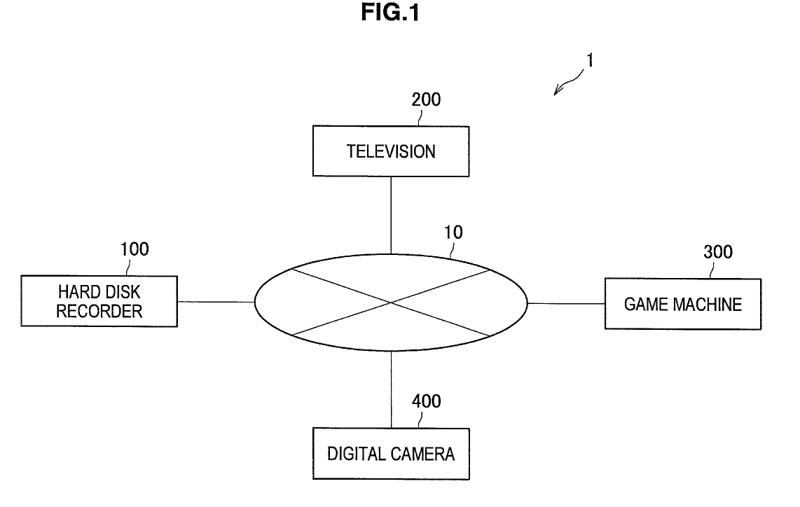

First, an exemplary configuration of a content sharing system in accordance with an embodiment of the present disclosure will be described with reference to the drawings. FIG. 1 is an explanatory diagram showing the configuration of a content sharing system 1 in accordance with an embodiment of the present disclosure. Hereinafter, the configuration of the content sharing system 1 in accordance with an embodiment of the present disclosure will be described with reference to FIG. 1.

As shown in FIG. 1, the content sharing system 1 in accordance with an embodiment of the present disclosure has a configuration in which a hard disk recorder 100, a television 200, a game machine 300, and a digital camera 400 are connected to each other over a home network 10. The home network 10 is a home network that is closed in units of a home or the like. Although FIG. 1 shows the hard disk recorder 100, the television 200, the game machine 300, and the digital camera 400, it is needless to mention that the devices that constitute the content sharing system in accordance with this embodiment are not limited thereto.

The hard disk recorder 100 has a hard disk drive or an optical disc drive, and has a function of recording a received broadcast on a hard disk or an optical disc in a predetermined format. The television 200 has a function of displaying a received broadcast. The game machine 300 has a hard disk drive or an optical disc drive, and has a function of executing a program having a game recorded thereon. The digital camera 400 has functions of capturing a still image or a moving image and recording the captured image on internal memory or an external recording medium such as a memory card.

In this embodiment, each of the hard disk recorder 100, the television 200, the game machine 300, and the digital camera 400 has a function of connecting to a network, and these devices can mutually transfer data to each other via the home network 10.

In this embodiment, the aforementioned devices connected to the home network 10 have a mechanism of efficiently sharing information with the other devices connected to the home network 10. By having such a mechanism, it becomes possible to avoid a plurality of devices connected to the home network 10 from executing the same operation and thus allow sharing of information among such devices without increasing the amount of communication or the amount of computation in the entire network.

Hereinafter, the configuration of the content sharing system 1 in accordance with an embodiment of the present disclosure will be described with reference to FIG. 1. Next, the functional configuration of each device connected to the home network 10 in accordance with an embodiment of the present disclosure will be described.

### [1-2. Functional Configuration of Device Connected to Home Network]

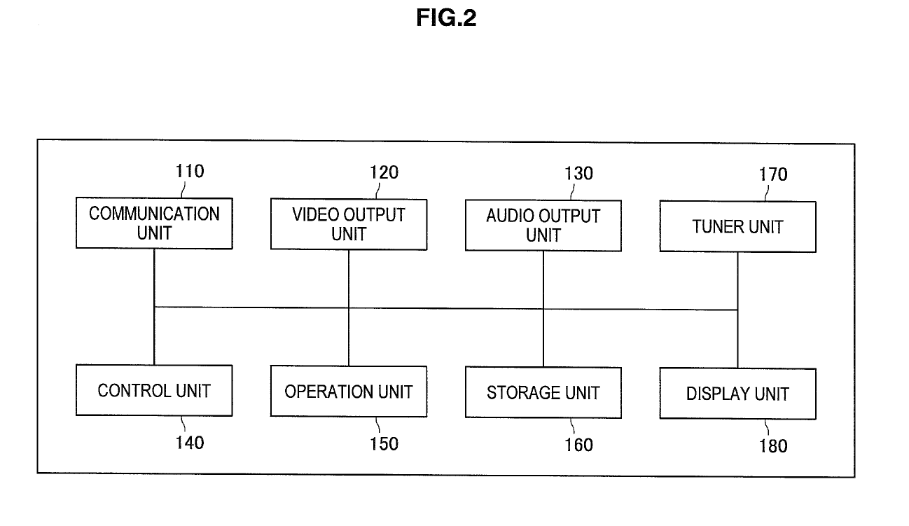

In the following description, the functional configuration of the hard disk recorder 100 will be described as an example of the functional configuration of a device connected to the home network. FIG. 2 is an explanatory diagram showing the functional configuration of the hard disk recorder 100. Hereinafter, the functional configuration of the hard disk recorder 100 in accordance with an embodiment of the present disclosure will be described with reference to FIG. 2.

As shown in FIG. 2, the hard disk recorder 100 in accordance with an embodiment of the present disclosure includes a communication unit 110, a video output unit 120, an audio output unit 130, a control unit 140, an operation unit 150, a storage unit 160, a tuner unit 170, and a display unit 180.

The communication unit 110 executes communication with another device connected to the home network 10 based on a predetermined protocol. In this embodiment, the communication unit 110 transmits data for sharing information with another device connected to the home network 10, stored in the storage unit 160, to a designated transmission destination device under the control of the control unit 140. In this embodiment, data for sharing information with another device connected to the home network 10 will be referred to as a “token.” A token can be created in any file format, for example, an XML (Extensible Markup Language) format.

The video output unit 120 outputs a video signal. The video output unit 120 outputs a predetermined video signal to, for example, a television or another display device such as a liquid crystal display (LCD) device or an OLED (Organic Light Emitting Display) device connected to the video output unit 120. The television or the display device connected to the video output unit 120 is configured to display video based on the video signal transmitted from the video output unit 120.

The audio output unit 130 outputs an audio signal. The audio output unit 130 outputs a predetermined audio signal to, for example, a speaker connected to the audio output unit 130. The speaker connected to the audio output unit 130 is configured to output audio based on the audio signal transmitted from the audio output unit 130.

The control unit 140 controls the operation of the hard disk recorder 100. Specifically, the control unit 140 controls wireless communication of the wireless communication unit 110, information display of the display unit 180, video signal output of the video output unit 120, audio signal output of the audio output unit 130, and the like. The control unit 140 includes, for example, a CPU (Central Processing Unit) or the like.

The operation unit 150 receives an operation of a user of the hard disk recorder 100. The operation unit 150 may include various buttons or sensors to operate the hard disk recorder 100. In addition, the operation unit 150 may include a touch panel integrated with the display unit 120. The control unit 140 controls the operation of the hard disk recorder 100 on the basis of a user operation on the operation unit 150.

The storage unit 160 includes ROM, RAM, a hard disk, flash memory, or the like, and stores computer programs, still image data, moving image data, or other types of electronic data for operating the hard disk recorder 100. The computer programs for operating the hard disk recorder 100, stored in the storage unit 160, are sequentially read and executed by the control unit 140. In addition, the still image data, moving image data, or other types of electronic data stored in the storage unit 160 are, once the user of the hard disk recorder 100 executes a predetermined operation on the hard disk recorder 100, transmitted from the wireless communication unit 110 on the basis of the operation.

The tuner unit 170 is configured to receive a broadcast and obtain a video signal and an audio signal from the received broadcast. A video signal obtained by the tuner unit 170 is output from the video output unit 120, and an audio signal is output from the audio output unit 130. When a recording process is executed by the control unit 140, the video signal and the audio signal are recorded on the storage unit 160.

The display unit 180 displays various predetermined information. Examples of the information displayed by the display unit 180 include the status of the hard disk recorder 100, the current time, and the playback time of the content being played back now.

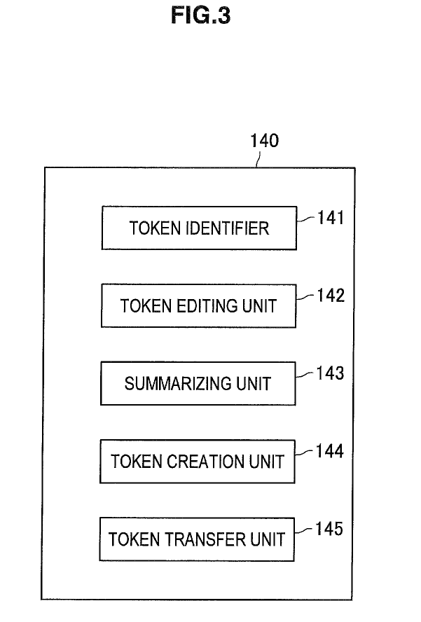

Next, the functional configuration of the control unit 140 included in the hard disk recorder 100 in accordance with an embodiment of the present disclosure will be described. FIG. 3 is an explanatory diagram showing the functional configuration of the control unit 140 included in the hard disk recorder 100. As shown in FIG. 3, the control unit 140 includes a token identifying unit 141, a token editing unit 142, a summarizing unit 143, a token creation unit 144, and a token transfer unit 145.

The token identifier unit 141, when a token is transferred from another device (e.g., the television 200) to the hard disk recorder 100, identifies information described in the token. The information described in the token will be described later. By identifying the information described in the token, the token identifying unit 141 selects an appropriate token from the transferred token.

The token editing unit 142 edits the transferred token. The token identifying unit 141 identifies the information described in the token, selects the appropriate token editing unit 142, and causes the selected token editing unit 142 to describe appropriate information.

Note that the token editing unit 142 may be configured to be provided in plural number in accordance with information (type) of a token. By configuring the token editing unit 142 to be provided in plural number in accordance with information (type) of a token, it becomes possible to, even when the types of tokens increase, flexibly construct the content sharing system 1 by increasing the number of the token editing units 142 in a scalable manner.

The summarizing unit 143 inquires of another device connected to the home network 10 about a unique identifier of the device or the capacity of the device, and summarizes the result of inquiry. The information on the other device connected to the home network 10, summarized by the summarizing unit 143, is transferred to the token creation unit 144.

The token creation unit 144, using the information on the other device connected to the home network 10, summarized by the summarizing unit 143, creates a token to be forwarded to the other devices. The token created by the token creation unit 144 is transferred to the other devices connected to the home network 10 by the token transfer unit 145.

The token transfer unit 145 transfers the token edited by the token editing unit 142 or created by the token creation unit 144 to the other devices via the communication unit 110. The token transfer unit 145 transfers the token to the other devices connected to the home network 10 in the order described in the token.

The control unit 140 can have a functional configuration such as the one shown in FIG. 3 by, for example, reading the computer program stored in the storage unit 160 and executing the read computer program.

The other devices connected to the home network 10, that is, the television 200, the game machine 300, and the digital camera 400 also have the configuration of the control unit 140 shown in FIG. 3. Thus, as each of the devices connected to the home network 10 has the configuration of the control unit 140 shown in FIG. 3, any device can create a token, and further, a token created by a given device can be forwarded to the other devices connected to the home network 10, so that the forwarded token can be shared among the devices connected to the home network 10. By forwarding a token to allow sharing of the forwarded token among the devices connected to the home network 10, it becomes possible to eliminate a wasteful process such that the plurality of devices execute the same process.

The functional configuration of the hard disk recorder 100 in accordance with an embodiment of the present disclosure has been described above. Next, the operation of a device connected to the home network 10 in accordance with an embodiment of the present disclosure will be described.

### [1-3. Operation of Device Connected to Home Network]

As described above, each device in accordance with an embodiment of the present disclosure connected to the home network 10 can inquire of other devices about identifiers and capacities of the devices and summarize the result of inquiry, and further create a token using the summarized information. A token created by a given device can be forwarded to the other devices connected to the home network 10. A device that has received the forwarded token can edit the token in accordance with the information on the token, and can further forward the edited token to another device.

As described above, as the creation and forwarding of a token are performed among the devices connected to the home network 10, it is possible to allow sharing of information among the devices connected to the home network 10 and avoid different devices from perform the same process (e.g., holding of the same content in different devices or execution of timer recording of the same program on the individual devices), thereby allowing efficient sharing of content.

Note that the token creation timing may be any given timing. Examples of the given timing include the timing when the determined date and time have reached, a point in time when power of each device connected to the home network 10 is turned on, and a point in time when the power of each device is turned off. Needless to say, the token creation timing is not limited thereto. In addition, each device connected to the home network 10 may concurrently forward two or more tokens.

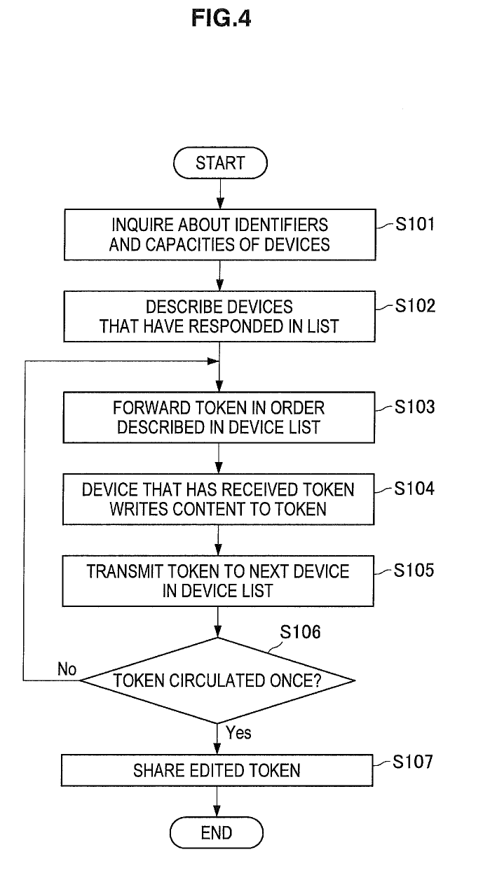

FIG. 4 is a flowchart showing the operation of a device connected to the home network 10. The flowchart shown in FIG. 4 shows an operation when the hard disk recorder 100 connected to the home network 10 makes an inquiry at another device (the television 200, the game machine 300, or the digital camera 400) to create a token, and then forwards the created token to another device, thereby sharing information. Hereinafter, the operation of the device connected to the home network 10 will be described with reference to FIG. 4.

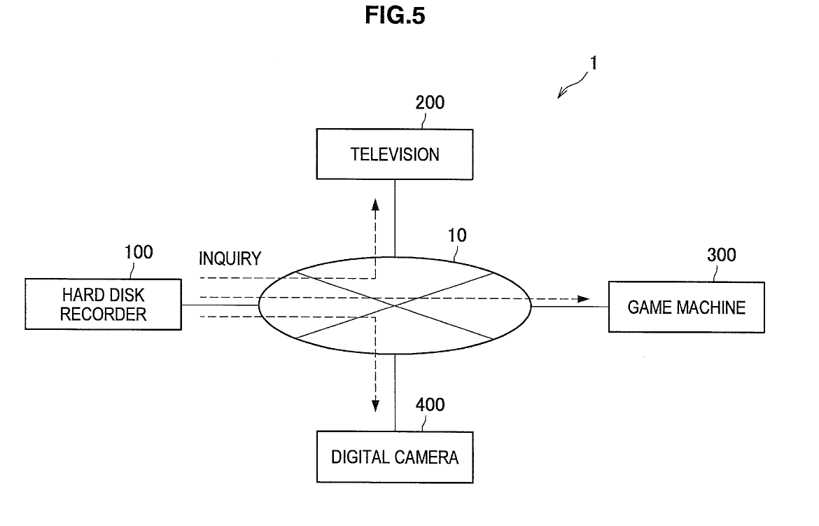

The hard disk recorder 100, using the summarizing unit 143, inquires of all devices that are connected to the home network 10 about the identifiers and capacities of the devices by broadcast (step S101). FIG. 5 is an explanatory diagram showing a summary of the operation of a device connected to the home network 10, and is an explanatory diagram showing a view in which the hard disk recorder 100 broadcasts signals to all devices that are connected to the home network 10.

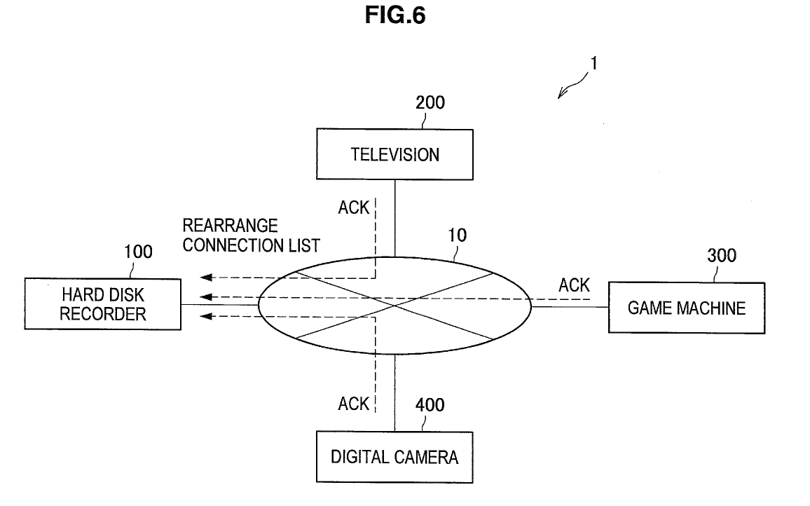

The hard disk recorder 100 summarizes, with the summarizing unit 143, the information transmitted from the device that has responded to the inquiry. FIG. 6 is an explanatory diagram showing a summary of the operation of the device connected to the home network 10, and is an explanatory diagram showing a view in which the hard disk recorder 100 broadcasts signals to all devices that are connected to the home network 10, and all the devices that are connected to the home network 10 respond to the hard disk recorder 100 (return ACK). Needless to say, some of the devices may not respond (do not return ACK) to the hard disk recorder 100 for some reasons (e.g., for reasons that power is turned off or the device cannot return a response as it is executing another process).

Then, the token creation unit 144 describes the information summarized by the summarizing unit 143 in a device list portion in the token (step S102). In addition, the token creation unit 144 describes the type of a content list to be acquired (e.g., a list of content to be played, a timer recording list, or an application list) in the content list type portion in the token. Then, the token creation unit 144 describes a flag (e.g., “Acquire”), which indicates that information is to be collected from now, in the mode portion in the token.

Then, the token creation unit 144 of the hard disk recorder 100 rearranges the device list portion in the created token in accordance with what strategy the content list has been created with. For this strategy, various cases are considered such as the capacities of the devices connected to the home network 10, for example, in descending order of the speed of response to the hard disk recorder 100, in descending order of the remaining storage capacity, or in increasing order of power consumption. Further, the token creation unit 144 describes information, which identifies itself (the hard disk recorder 100), at the end of the device list portion. Accordingly, a token created by the token creation unit 144 finally returns to itself (the hard disk recorder 100).

Hereinafter, description will be made on the assumption that a device list portion in a token is rearranged in the following order by the hard disk recorder 100: the television 200, the game machine 300, and the digital camera 400.

Next, the hard disk recorder 100 forwards the token in the order described in the device list (step S103). The token created by the token creation unit 144 is transferred to a device described at the top of the device list portion (herein, the television 200) by the token transfer unit 145.

The television 200 that has received the token transferred from the hard disk recorder 100 first executes identification of the content list type portion in the token received by the token identifying unit 141. When the token identifying unit 141 identifies the content list type portion in the token, the token identifying unit 141 selects the token editing unit 142 in accordance with the content list type portion. The selected token editing unit 142 writes its own content list in the content list portion in the token (step S104).

When the token editing unit 142 writes its own content list in the content list portion in the token in step S104 above, the token transfer unit 145 transfers the token to the next device (the game machine 300) described in the device list portion (step S105).

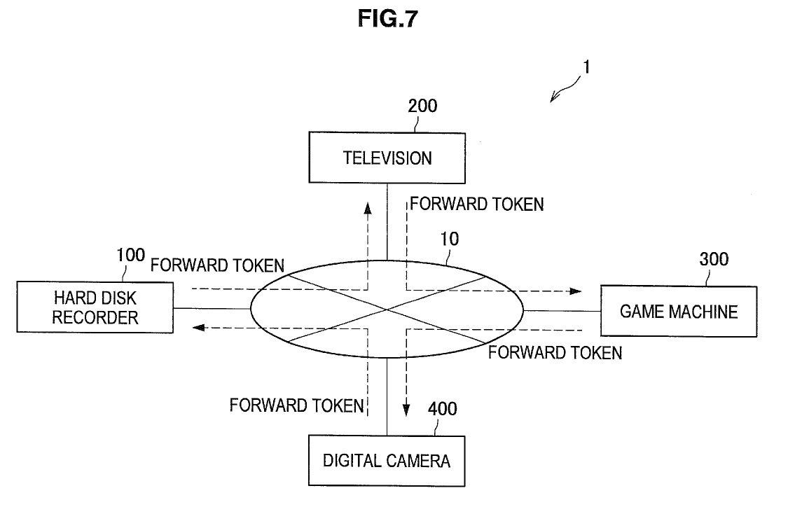

As described above, all devices that are described in the device list portion of the token are caused to sequentially execute transfer and editing of the token. If the token has circulated once is determined (step S106), and if the token has not circulated once, transfer and editing of the token are sequentially executed in the devices described in the device list portion of the token. Meanwhile, if the token has circulated once, that is, if the token has returned to the hard disk recorder 100, it means that the content lists of the devices connected to the home network 10 are described in the token. FIG. 7 is an explanatory diagram showing a summary of the operations of devices connected to the home network 10, and is an explanatory diagram showing a view in which tokens are sequentially forwarded among the devices connected to the home network 10.

Then, when editing of the token is completed in all devices that are connected to the home network 10 including the hard disk recorder 100 that has created the token, the edited token is sequentially forwarded among the devices connected to the home network 10 in a similar way, whereby the token is shared among all devices. When sharing a token, for example, the token creation unit 144 of the hard disk recorder 100 changes the mode of the token to a flag (e.g., “Share”) indicating that the token is to be shared, and causes the token to circulate once more.

The television 200 that has received the token transferred from the hard disk recorder 100, if the token identification unit (which has the same function as the token identification unit 141 provided in the control unit 140 of the hard disk recorder 100) identifies the mode of the transferred token and the mode is identified as a flag indicating that the token is to be shared, stores the content list described in the transferred token into its storage unit. Upon storing the content list described in the token into its storage unit, the television 200 transfers the token to the game machine 300.

Thereafter, the game machine 300 and the digital camera 400 similarly store the content list described in the token in their storage units. The digital camera 400 returns the token to the hard disk recorder 100. When the token finally returns to the hard disk recorder 100, it follows that information on the content list described in the token is shared among all devices that are connected to the home network 10.

As described above, when all devices that are connected to the home network 10 create a token, and the created token is forwarded to the other devices connected to the home network 10, it becomes possible to allow information (a content list) in the device connected to the home network 10 to be shared among all devices.

Note that there are possibilities that when the hard disk recorder 100 executes broadcast, a token may not be forwarded if the power is turned off or if the device is disconnected from the home network 10, for example, although it is the device described in the token. In view of such case, a timeout-out period may be set when a token is transferred, and if the token is not transferred, the device may be skilled and the token may be transferred to the next device.

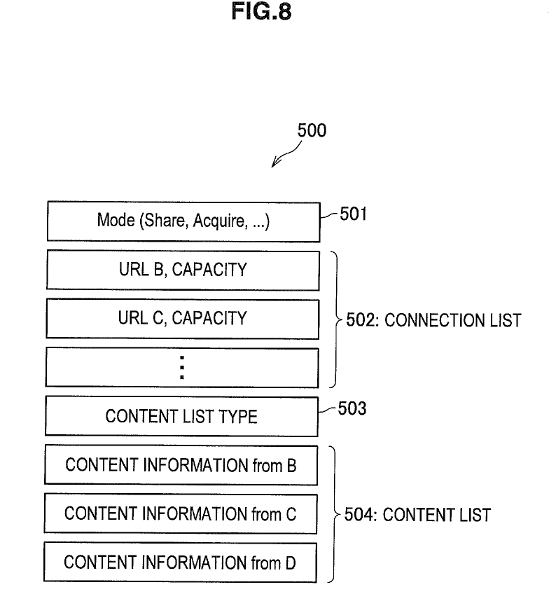

Herein, an exemplary format of a token created by any of the devices in accordance with an embodiment of the present disclosure, connected to the home network 10, will be described. FIG. 8 is an explanatory diagram showing an exemplary format of a token created by any device.

The token 500 shown in FIG. 8 includes a mode portion 501, a connection list portion 502, a content list type portion 503, and a content list portion 504.

The mode portion 501 is a region for distinguishing whether the forwarded token 500 has a mode of collecting information or a mode of sharing information. In the mode of collecting information, “Acquire” or the like is described in the mode portion 501, for example, and in the mode of sharing information, “Share” or the like is described in the mode portion 501, for example.

The connection list portion 502 is a region for a device that creates a token (the hard disk recorder 100 in the aforementioned description) to describe information on another device connected to the home network 10 that has responded to the inquiry. A token created by any of the devices connected to the home network 10 is transferred in the order described in the connection list portion 502. As described above, the device list described in the connection list portion 502 is rearranged by the token creation unit 144 in accordance with what strategy a content list should be created with. For example, the token creation unit 144 may rearrange the device list described in the connection list portion 502 using, as a key, the time until when a response is returned from another device, in descending order of the remaining storage capacity, or in increasing order of power consumption.

The content list type portion 503 is a region for describing the type of a content list to be shared using the token 500. Examples of the type of a content list include a content list, a timer recording list, an application list, or the like held by each device. The token identification unit 141 may, upon receiving the token 500, check the content list type portion 503 in the received token 500, and select the token editing unit 142 in accordance with the information described in the content list type portion 503.

The content list portion 504 is a region for describing a content list in accordance with the type of the content list described in the content list type portion 503. In the content list portion 504, a content list in accordance with the type of the content list described in the content list type portion 503 is described by the token editing unit 142.

When the thus defined token 500 is created by any device connected to the home network 10 and is forwarded to another device connected to the home network 10, a token having described therein a content list in accordance with a content list type is completed. When the completed token is forwarded to another device connected to the home network 10, it becomes possible for the devices connected to the home network 10 to share information on the content list.

Herein, some of specific processes that are performed in accordance with a content list type will be exemplarily described. In the following description, the hard disk recorder 100 creates a token, and the created token is forwarded to another device. First, a process performed when all devices that are connected to the home network 10 want to share a playlist will be described.

In the hard disk recorder 100, the token creation unit 144, when creating a token 500, describes a list of devices each having a storage function as the capacity in the connection list portion 502 of the token 500. In addition, the token creation unit 144 describes in the content list type portion 503 of the token 500 a symbol (e.g., “Video”) representing a playlist as the type.

Then, the token creation unit 144, using as a key the time until when a response is returned from a device to which a signal has been broadcast, rearranges the list of the connection list portion 502, and the token transfer unit 145 transfers the token 500 created by the token creation unit 144 to the head device in the connection list portion 502.

In a device that has received the transferred token 500, the token editing unit 142 writes a content playlist held by the device to the content list portion 504 of the token 500. At this time, if the same content is already recorded on the content list portion 504 of the token 500, the token editing unit 142 does not write such content. Accordingly, a content list written in the content list portion 504 by the devices connected to the home network 10 becomes a playlist in which pieces of content are described in order of decreasing accessible speed.

When the content list portion 504 of the token 500 is updated to the playlists of content held by all devices that are connected to the home network 10 and have a storage function as the capacity, the hard disk recorder 100 that has created the token forwards the token 500 to the devices described in the connection list portion 502 of the token 500. Accordingly, devices connected to the home network 10 and having a storage function as the capacity can share information on the content playlist.

Next, a process that is performed to avoid overlapped timer recording among all devices that are connected to the home network 10 will be described.

In the hard disk recorder 100, the token creation unit 144, when creating a token 500, creates a list of devices each having a recording function as the capacity, and describes such device list in the connection list portion 502 of the token 500. In addition, the token creation unit 144 describes in the content list type portion 503 of the token 500 “Recording” as a symbol representing a timer recording list as the type, for example.

Then, the token creation unit 144 rearranges the list of the connection list portion 502 using the power consumption of the devices as a key, and the token transfer unit 145 transfers the token 500 created by the token creation unit 144 to the head device in the connection list portion 502.

In the device that has received the transferred token 500, the token editing unit 142 writes a timer recording list held by the device to the content list portion 504 of the token 500. At this time, if the content list portion 504 of the token 500 already has recorded thereon timer recording of the same program, the token editing unit 142 does not write such timer recording list, and deletes its own timer recording list. Accordingly, a content list created in the aforementioned procedure and is described in the content list portion 504 by the devices connected to the home network 10 becomes a reservation list that allows a reduction in power consumption and avoids overlaps.

When the content list portion 504 of the token 500 is updated to the timer recording lists held by all devices that are connected to the home network 10 and have a recording function as the capacity, the hard disk recorder 10 that is the device having created the token forwards the token 500 to the devices described in the connection list portion 502 of the token 500. Accordingly, devices connected to the home network 10 and having a recording function as the capacity can share information on the timer recording list of the program.

Next, a process that is performed when all devices that are connected to the home network 10 want to share application list information will be described.

In the hard disk recorder 100, the token creation unit 144, when creating a token 500, describes a list of devices each having an application execution function as the capacity in the connection list portion 502 of the token 500. In addition, the token creation unit 144 describes in the content list type portion 503 of the token 500 “Application” as a symbol representing an application list as the type.

Then, the token transfer unit 145 transfers the token 500 created by the token creation unit 144 to the head device in the connection list portion 502.

In the device that has received the transferred token 500, the token editing unit 142 writes a list of applications, which can be executed on another device, to the content list portion 504 of the token 500. At this time, if the content list portion 504 of the token 500 already has recorded thereon the same application but the version of the application of the device is newer than that of the content recorded on the content list portion 504 of the token 500, the application is updated to the newer one. Accordingly, a content list created in the aforementioned procedure and is described in the content list portion 504 by the devices connected to the home network 10 becomes a list of applications of the latest version.

When the content list portion 504 of the token 500 is updated to application lists of all devices that are connected to the home network 10 and have an application execution function as the capacity, the hard disk recorder 100 that has created the token forwards the token 500 in order of the devices described in the connection list portion 502 of the token 500.

As described above, when a token is forwarded to all devices that are connected to the home network 10 and have an application execution function as the capacity, it becomes possible for the devices that are connected to the home network 10 and have an application execution function as the capacity to share information on the latest application list. The applications in the list can be executed by the other devices. Thus, for example, it becomes possible for the television 200 to execute an application held by the digital camera 400 (e.g., an application that executes a slide show).

Next, a process that is performed when all devices that are connected to the home network 10 want to share service information (SI) will be described.

In the hard disk recorder 100, the token creation unit 144, when creating a token 500, describes a list of devices each having a digital tuner as the capacity in the connection list portion 502 of the token 500. In addition, the token creation unit 144 describes in the content list type portion 503 of the token 500 “Service Information” as a symbol representing an application list as the type, for example.

Then, the token transfer unit 145 transfers the token 500 created by the token creation unit 144 to the head device in the connection list portion 502.

In the device that has received the transferred token 500, the token update unit 142 writes a list of program information, which has been already acquired, to the content list portion 504 of the token 500. Accordingly, the content list that is created in the aforementioned procedure and is described in the content list portion 504 by the device connected to the home network 10 becomes a list of program information at the digital tuner.

When the content list portion 504 of the token 500 is updated to the program information list acquired by all devices that are connected to the home network 10 and have digital tuners as the capacity, the hard disk recorder 100 that has created the token forwards the token 500 to the devices described in the connection list portion 502 of the token 500. Accordingly, devices that are connected to the home network 10 and have an execution function of digital tuners as the capacity can share information on the program lists acquired by the digital tuners.

Note that when a token is circulated only once through all devices that are connected to the home network 10 and have digital tuners as the capacity, it is conceivable that the acquisition of program information is not complete. In such a case, when sharing a token, a device that has received the token may randomly select information on the service that has not been acquired yet and acquire program information of the service. Accordingly, a plurality of devices that are connected to the home network 10 can collect program information in a distributed manner.

### 2. Conclusion

As described above, according to an embodiment of the present disclosure, a given device that is connected to the home network 10 creates a token, and the created token is circulated through all devices that are connected to the home network 10, whereby in sharing of information, a network load can be reduced than is conventionally done.

By adjusting the order of the device list of the created token, it becomes possible to, if a device with lower power consumption is preferentially used, for example, suppress power consumption. Meanwhile, it becomes possible to, if a device with a faster access speed is preferentially used, improve the access speed. In addition, if information on applications is shared, it becomes possible to, only by connecting a device to a network, execute a new function at a device other than the device, and obtain, if a plurality of the same applications reside in the network, an advantageous effect that is the same as the effect obtained when an application is updated to the latest information. Further, if program information is acquired in a distributed manner, it becomes possible to collect the information at a high speed.

The existing DLNA uses a client/server model, and the server is responsible for providing a content list, while the client acquires a device list. In the existing DLNA, however, as the servers have no function of interoperating with each other, the client should acquire lists from all servers and solve the problem of overlaps.

In addition, in the existing DLNA, there is no means to share the collected lists. Thus, all clients should perform the same process. Therefore, in the existing DLNA, the amount of communication and the amount of computation for the client to acquire lists from all servers and share the lists are enormous.

In contrast, in an embodiment of the present disclosure, a process of acquiring lists to solve the problem of overlaps is performed in a distributed manner by devices that are connected to a home network. Therefore, in an embodiment of the present disclosure, the amount of communication and the amount of computation for sharing lists across the entire network can be suppressed than in the existing DLNA. Further, as tokens can be created by a plurality of devices at the same timing and the created tokens can be forwarded, it is possible to, in an embodiment of the present disclosure, create a recording list while at the same time creating a playlist, for example.

Note that in this specification, the steps described in the flowchart include not only processes that are performed in a time series order in accordance with the order described in the flowchart but also processes that are processed in parallel or individually. Further, it is needless to mention that even the steps that are processed in a time series order may be performed by changing the order as appropriate according to circumstances.

It should be understood by those skilled in the art that various modifications, combinations, sub-combinations and alterations may occur depending on design requirements and other factors insofar as they are within the scope of the appended claims or the equivalents thereof.

Additionally, the present technology may also be configured as below.

(1) An information processing device comprising:

a device information acquisition unit configured to acquire information on other devices connected via a network; and

a setting file creation unit configured to, on the basis of the information on the other devices acquired by the device information acquisition unit, create a setting file by causing the information processing device to describe in the setting file information on content that is managed by the information processing device, the setting file being adapted to be forwarded to the other devices, wherein

the setting file creation unit describes in the setting file an order in which the setting file is to be forwarded.

(2) The information processing device according to (1), wherein the setting file creation unit determines the order in which the setting file is to be forwarded on the basis of the information on the other devices acquired by the device information acquisition unit and describes the order in the setting file.

(3) The information processing device according to (2), wherein the setting file creation unit determines the order in which the setting file is to be forwarded on the basis of capacities of the other devices acquired by the device information acquisition unit and describes the order in the setting file.

(4) The information processing device according to (3), wherein the capacities of the other devices acquired by the device information acquisition unit are information about functions of the other devices.

(5) The information processing device according to any one of (1) to (4), further comprising:

a setting file identifying unit configured to, when a setting file is forwarded from another device, identify information described in the setting file;

a setting file update unit configured to update the setting file on the basis of the information identified by the setting file identifying unit; and

a setting file transfer unit configured to transfer the setting file updated by the setting file update unit to a next device.

(6) The information processing device according to (5), wherein the setting file update unit writes to the setting file a list of content managed by the information processing device on the basis of the information identified by the setting file identifying unit.

(7) The information processing device according to any one of (1) to (6), wherein information on the content managed by the information processing device, described by the information processing device, is information on a playlist of the content.

(8) The information processing device according to any one of (1) to (7), wherein information on the content managed by the information processing device, described by the information processing device, is information on a timer recording list of the content.

(9) The information processing device according to any one of (1) to (8), wherein information on the content managed by the information processing device, described by the information processing device, is information on a version of an application.

(10) The information processing device according to any one of (1) to (9), wherein information on the content managed by the information processing device, described by the information processing device, is detailed information on a program.

(11) An information processing method, comprising:

a device information acquisition step of acquiring information on other devices connected via a network; and

a setting file creation step of, on the basis of the information on the other devices acquired by the device information acquisition step, creating a setting file by causing a device to describe in the setting file information on content that is managed by the device, the setting file being adapted to be forwarded to the other devices, wherein

the setting file creation step describes in the setting file an order in which the setting file is to be forwarded.

(12) A computer program for causing a computer to execute:

a device information acquisition step of acquiring information on other devices connected via a network; and

a setting file creation step of, on the basis of the information on the other devices acquired by the device information acquisition step, creating a setting file by causing a device to describe in the setting file information on content that is managed by the device, the setting file being adapted to be forwarded to the other devices, wherein

the setting file creation step describes in the setting file an order in which the setting file is to be forwarded.

What is claimed is:

1. An information processing device comprising:
a device information acquisition unit configured to acquire information on other devices connected via a network; and
a setting file creation unit configured to, on the basis of the information on the other devices acquired by the device information acquisition unit, create a setting file by causing the information processing device to describe in the setting file information on content that is managed by the information processing device, the setting file being adapted to be forwarded to the other devices, wherein
the setting file creation unit describes in the setting file an order in which the setting file is to be forwarded.

2. The information processing device according to claim 1, wherein the setting file creation unit determines the order in which the setting file is to be forwarded on the basis of the information on the other devices acquired by the device information acquisition unit and describes the order in the setting file.

3. The information processing device according to claim 2, wherein the setting file creation unit determines the order in which the setting file is to be forwarded on the basis of capacities of the other devices acquired by the device information acquisition unit and describes the order in the setting file.

4. The information processing device according to claim 3, wherein the capacities of the other devices acquired by the device information acquisition unit are information about functions of the other devices.

5. The information processing device according to claim 1, further comprising:
a setting file identifying unit configured to, when a setting file is forwarded from another device, identify information described in the setting file;
a setting file update unit configured to update the setting file on the basis of the information identified by the setting file identifying unit; and
a setting file transfer unit configured to transfer the setting file updated by the setting file update unit to a next device.

6. The information processing device according to claim 5, wherein the setting file update unit writes to the setting file a list of content managed by the information processing device on the basis of the information identified by the setting file identifying unit.

7. The information processing device according to claim 1, wherein information on the content managed by the information processing device, described by the information processing device, is information on a playlist of the content.

8. The information processing device according to claim 1, wherein information on the content managed by the information processing device, described by the information processing device, is information on a timer recording list of the content.

9. The information processing device according to claim 1, wherein information on the content managed by the information processing device, described by the information processing device, is information on a version of an application.

10. The information processing device according to claim 1, wherein information on the content managed by the information processing device, described by the information processing device, is detailed information on a program.

11. An information processing method, comprising:
a device information acquisition step of acquiring information on other devices connected via a network; and
a setting file creation step of, on the basis of the information on the other devices acquired by the device information acquisition step, creating a setting file by causing a device to describe in the setting file information on content that is managed by the device, the setting file being adapted to be forwarded to the other devices, wherein
the setting file creation step describes in the setting file an order in which the setting file is to be forwarded.

12. A computer program for causing a computer to execute:
a device information acquisition step of acquiring information on other devices connected via a network; and
a setting file creation step of, on the basis of the information on the other devices acquired by the device information acquisition step, creating a setting file by causing a device to describe in the setting file information on content that is managed by the device, the setting file being adapted to be forwarded to the other devices, wherein
the setting file creation step describes in the setting file an order in which the setting file is to be forwarded.
